(19) United States
(12) Patent Application Publication
(10) Pub. No.: US 2025/0310257 A1
(43) Pub. Date: Oct. 2, 2025

(54) DISAGGREGATION FROM NETWORK APPLIANCES TO HARDWARE-BASED NETWORK DEVICES IN SOFTWARE DEFINED NETWORKS

(71) Applicant: MICROSOFT TECHNOLOGY LICENSING, LLC, Redmond, WA (US)

(72) Inventors: Rishabh TEWARI, Sammamish, WA (US); Gerald Roy DE GRACE, Cumming, GA (US); Michal Czeslaw ZYGMUNT, Kirkland, WA (US); Deepak BANSAL, Bellevue, WA (US); Pranjal SHRIVASTAVA, Redmond, WA (US); Abhijeet KUMAR, Sammamish, WA (US)

(21) Appl. No.: 18/622,926

(22) Filed: Mar. 30, 2024

(51) Int. Cl. H04L 45/76; H04L 45/74

(52) U.S. Cl. CPC H04L 45/76; H04L 45/74

(57) ABSTRACT

Flows of a communication session in a software defined network (SDN) are efficiently managed. A network virtual appliance offloads, to a hardware-based network interface device, processing of data packets of a flow in accordance with packet processing rules associated with the flow. After the offload, subsequent data packets for the offloaded flow are processed and forwarded by the hardware-based network interface device without forwarding to the network virtual appliance.

### BACKGROUND

A data center houses computer systems and various networking, storage, and other related components. Data centers, for example, are used by service providers to provide computing services to businesses and individuals as a remote computing service or provide “software as a service” (e.g., cloud computing). Software defined networking (SDN) enables centralized configuration and management of physical and virtual network devices as well as dynamic and scalable implementation of network policies. The efficient processing of data traffic and efficiently utilizing the physical and virtual network devices are important for maintaining scalability and efficient operation in such networks.

It is with respect to these considerations and others that the disclosure made herein is presented.

### SUMMARY

The present disclosure describes various techniques and systems for optimizing the operation of a cloud network to more efficiently utilize computing and networking resources by offloading and disaggregating processing performed by network virtual appliances (NVAs). Many cloud architectures offload networking stack tasks from virtual machines for implementing policies such as tunneling for virtual networks. By offloading such processing tasks to hardware-based network devices such as a smart network interface card (sNIC) or an SDN appliance or data processing unit (DPU) comprising multiple sNICs, the capacity of CPU cores can be reserved for running other cloud services and reducing latency and variability to network performance. However, many services for virtual network appliances that are implemented in SDNs such as firewalls, load balancers, application gateways, edge services, etc. are still performed by the virtual appliances running on virtual machines. This can result in inefficient use of computing resources and limit network bandwidth. While the services provided by the network virtual appliances can be implemented on virtual machines to perform the above-described functions, the processing of packets for an established flow requires significant processing and network resources.

The disclosed embodiments provide a way to offload and disaggregate processing functions (such as packet processing) from network virtual appliances to hardware-based network devices such as a smart network interface card (sNIC) or an SDN appliance or data processing unit (DPU) comprising multiple sNICs in order to increase efficiency and reduce consumption of core processing and other resources. Disaggregation of processing functions (such as packet processing) from network virtual appliances refers to allocation of functions from the network virtual appliances so that they need not be performed and co-located on the network virtual appliance, which is typically implemented on a virtual machine running on a general-purpose server.

The disclosed embodiments provide a way for hardware-based network devices to perform these network virtual appliance services, for example in the SDN appliance or DPU, and disaggregate these functions from VMs running on server hosts and freeing up VM resources for other tasks. The hardware-based network device can perform these functions without the need to invoke software-based processing in VMs. For example, the DASH (Disaggregated APIs for SONIC Hosts) device, for example, can be used to house and offer packet processing and forwarding services without user traffic having to enter a network virtual function running on a server host, greatly reducing cost and latency.

The described techniques can allow for virtual computing environments to support a variety of configurations while maintaining efficient use of computing resources such as processor cycles, memory, network bandwidth, and power. This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### DESCRIPTION OF THE DRAWINGS

The Detailed Description is described with reference to the accompanying figures. In the description detailed herein, references are made to the accompanying drawings that form a part hereof, and that show, by way of illustration, specific embodiments or examples. The drawings herein are not drawn to scale. Like numerals represent like elements throughout the several figures.

FIG. 1A is a diagram illustrating an example architecture in accordance with the present disclosure.

FIG. 1B is a diagram illustrating an example architecture in accordance with the present disclosure.

FIG. 1C is a diagram illustrating an example architecture in accordance with the present disclosure.

FIG. 1D is a diagram illustrating an example architecture in accordance with the present disclosure.

FIG. 1E is a diagram illustrating an example architecture in accordance with the present disclosure.

FIG. 1F is a diagram illustrating an example architecture in accordance with the present disclosure.

FIG. 2 is a diagram illustrating an example connection record in accordance with the present disclosure;

FIG. 3 is a flowchart depicting an example procedure in accordance with the present disclosure;

FIG. 4 is an example computing system in accordance with the present disclosure;

FIG. 5 is a diagram illustrating a data center in accordance with the present disclosure;

FIG. 6 is a diagram illustrating an example system in accordance with the present disclosure.

### DETAILED DESCRIPTION

The disclosed embodiments enable datacenters to provide services in a manner that can reduce the cost and complexity of their networks, allowing for more efficient use of computing, storage, and network resources. Efficient implementation of the end-to-end service by a cloud service provider can enable an experience that is seamless and more consistent across various footprints. The integration of multi-tenant and single-tenant resources with a comprehensive resource management approach can also minimize the overhead for the user, who will not need to address policy enforcement issues and perform other complex management tasks. The efficient implementation of the described offload capabilities can provide improvements for various performance and security metrics such as latency and data security.

The present disclosure describes embodiments for optimizing the processing of data flows in SDNs that are running network virtual appliances, and where SDN includes smart NICs or sNICs (which can also be referred to as floating NICs or fNICs), network processing units (NPUs) and data processing units (DPUs) in smart switches and other devices such as SDN appliances, and various other devices to efficiently manage connections and utilization of associated services. An NPU, in one example, is a processing component that is configured for networking applications such as in routers, network switches, session controllers, firewall devices, and the like. A DPU, in one example, is a processing component that is configured for packet processing and can be implemented as hardware, software, or a combination. In one embodiment, the NPU or DPU is implemented as an ASIC. The various described acceleration devices can generally be referred to as hardware-based network interface devices.

Packet processing in SDNs can include fast path and slow path processing within a programmable data path. The slow path evaluates every connection (data flow) against a set of rules that can be complex in nature. The rules dictate whether a packet is allowed to continue to its destination either directly or through an intermediate device. A destination can also be referred to as an endpoint, which can be a virtual machine or other node. For example, the rules can cover allow, deny, or mirror actions as well as the transformation that the packet must undergo including any modification to the packet or tunnel layers. The rules can be applied in both directions for any packet that leaves or attempts to enter a virtual machine (VM) or container. Cloud environments typically support this type of functionality to ensure that virtual machines remain within their virtual network and are not allowed to access any other virtual networks or networking functions.

The processing associated with such packet processing can be complex and consist of many rules and related tables. After the processing is complete for the first packet of a connection (this processing is referred to as the “slow path”), the connection can subsequently be matched according to the connection's 5 tuple without performing the full rule processing. For this reason, the connection can be placed into a “fast path” where the exact matched connection and transformation can be consulted using much simpler table lookup algorithms. This results in much higher ongoing performance for established connections.

The present disclosure provides a way for a network virtual appliance to offload data flows to acceleration devices such as a floating (or smart) NIC, SDN appliance, digital processing unit (DPU) complex, etc. The network virtual appliance can process the first packet of a flow (aka “slow path”) where the packet is evaluated against a set of rules and actions that can dictate routing, destination, transformations, etc. After the processing is complete for the first packet of a connection, the network virtual appliance can offload processing of subsequent packets to one or more floating NICs or other accelerator devices.

Methods for creating a fast path connection record when a SYN packet arrives can be similar to what is commonly referred to as “slow path” as described in Disaggregated APIs for SONIC Hosts (DASH) open-source documentation found within Github. Connection flows can be re-simulated using the techniques described in application Ser. No. 17/855,730 “RE-SIMULATION OF UPDATED SDN CONNECTION FLOWS” filed Jun. 30, 2022, the contents of which are incorporated herein by reference. State synchronization can be achieved using the techniques described in application Ser. No. 17/958,346 “EFFICIENT STATE REPLICATION IN SDN NETWORKS” filed Oct. 1, 2022, the contents of which are incorporated herein by reference.

In an embodiment, a protocol enables such data flows to be offloaded from the network virtual appliance to the floating NIC using, for example, a flow offload packet. The flow offload packet can be implemented in one implementation as a FastpPath++ packet as described in application Ser. No. 18/620,725 “SMART SWITCH FOR OFFLOADING HIGH BANDWIDTH FLOWS IN A SOFTWARE DEFINED NETWORK” filed Mar. 28, 2024, the contents of which are incorporated herein by reference.

In some embodiments, the connection's 5 tuple can be used to match the connection without performing the full rule processing. By offloading processing of subsequent (e.g., after the first packet) to the floating NIC, higher ongoing performance for the network virtual appliance is enabled for established connections. This allows for reduction of the amount of traffic flowing through the network virtual appliance, and enables the network virtual appliance to use a smaller VM as most of the bandwidth is being handled by the floating NIC after the first packet. The offload relationship between the network virtual appliance and acceleration devices can be one-to-one, many-to-one, and one-to-many, e.g.:
1:1—1 NVA, 1 fNIC
1: many—1 NVA, many fNIC
many: 1—many NVA, 1 fNIC

Thus a single virtual appliance can offload flows to a single fNIC to realize increased flow capacity, but also offload flows to multiple fNICs to realize even greater capacities. The NVA, for example, can load balance among multiple fNICs. In other embodiments, multiple virtual appliances can offload flows to a single fNIC if the fNIC has capacity. Thus the allocation of fNICs to handle offloaded flows from virtual appliances can be varied according to the needs of the service provider. Additionally, the NVA can selectively offload flows or connections on a case by case basis.

To illustrate in one example, the first packet is processed according to the following flow:
SRC->DPU->NVA VM->DPU->DST

After flow offload from the NVA to the floating NIC:
SRC->DPU->DST (complete bypass of NVA)

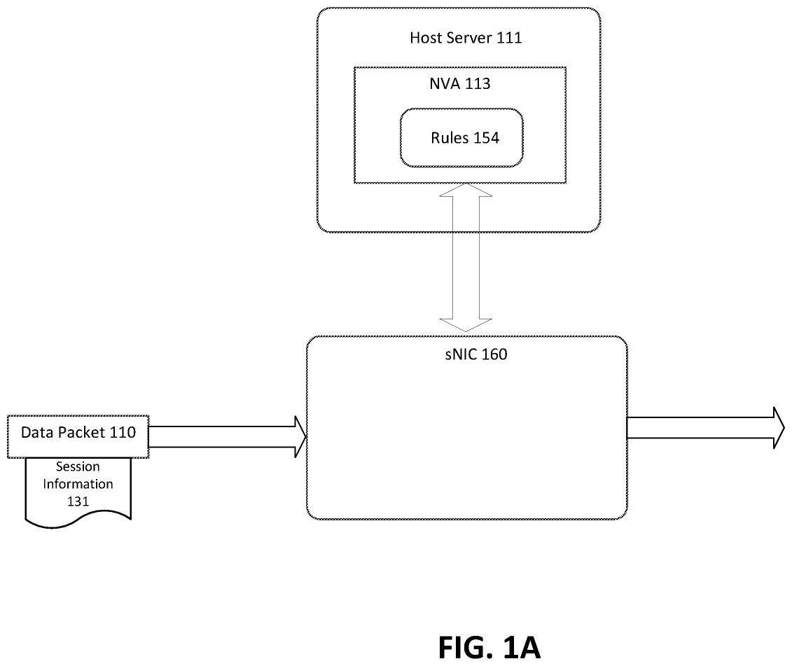

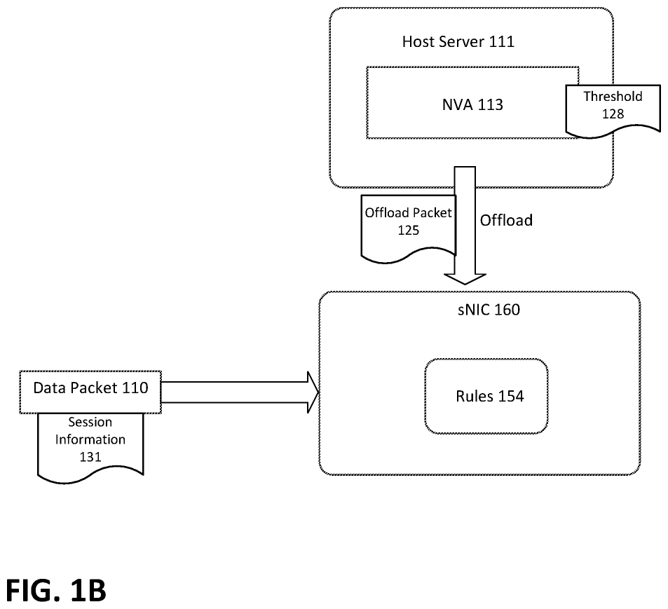

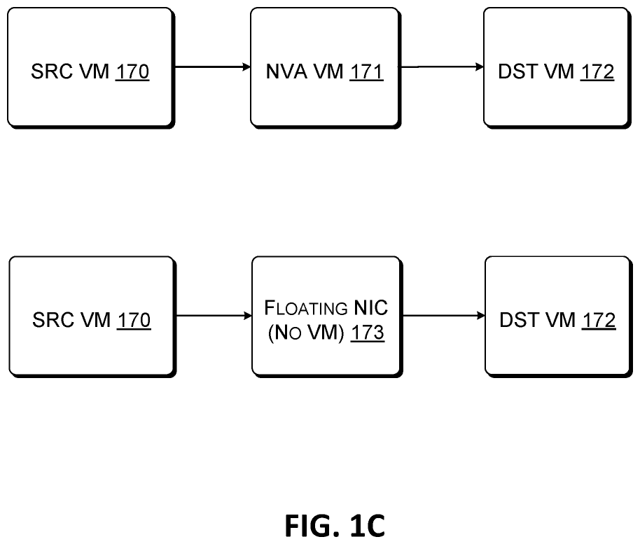

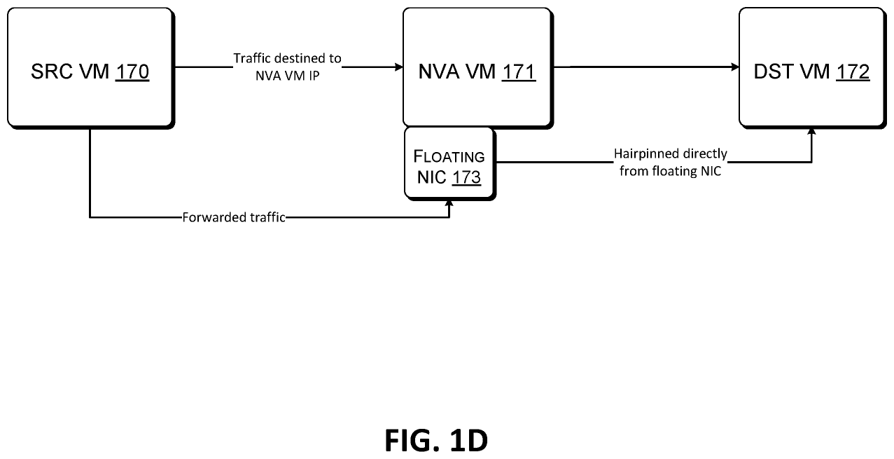

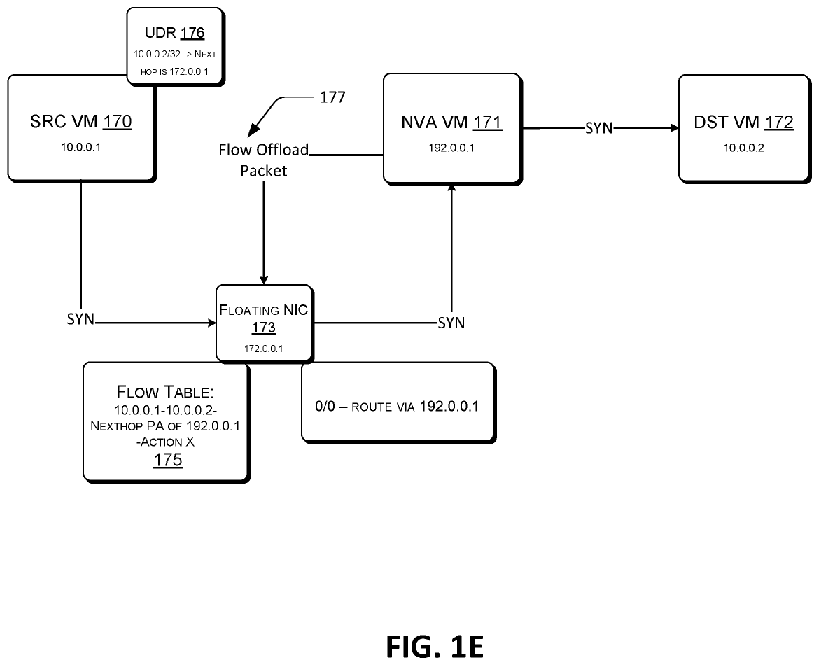

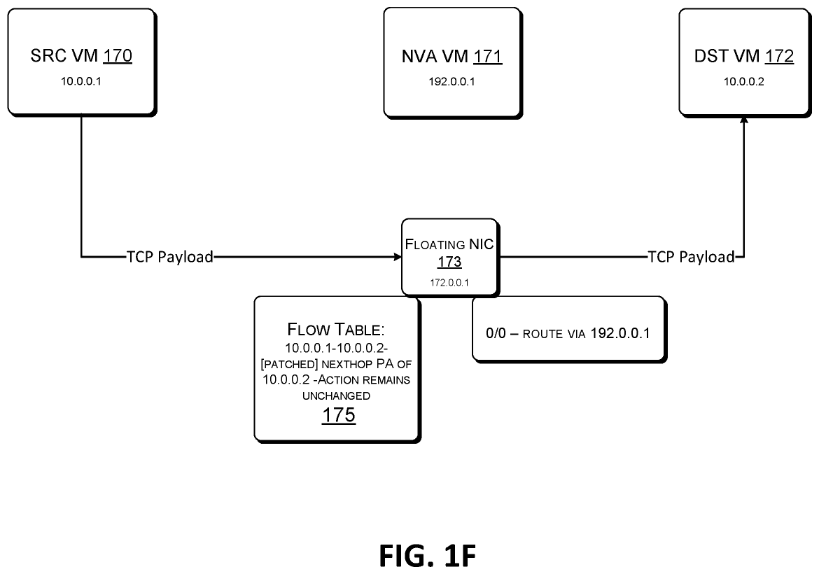

In one embodiment, the complete NVA functionality can be offloaded to the fNIC. In one implementation, a user-defined routine (UDR) is added to the fNIC to achieve the end-to-end scenario. Referring to FIG. 1C, illustrated is an example flow through a NVA 171 from source VM 170 to destination VM 172. FIG. 1C illustrates an example where a flow is offloaded to floating NIC 173 and thus subsequent packets are processed by floating NIC 173 and sent to destination VM 172 without being further processed or touched by NVA 171 which may be running on a VM. Thus the complete NVA functionality is implemented on the fNIC 173. In one example, the NVA or other user can add a user-defined routine (UDR) to the fNIC to achieve the end-to-end functionality.

In one embodiment, the fNIC can be attached to a VM with co-processing rules. In one implementation, a local IP can be used for offload. Referring to FIG. 1D, illustrated is an example flow through a NVA 171 from source VM 170 to destination VM 172. FIG. 1D illustrates an example where a first packet is routed to the NVA 171 (via the IP address of the VM on which the NVA is running) for processing and then forwarded to the destination VM 172. After the flow is offloaded to floating NIC 173, subsequent traffic is forwarded to the floating NIC 173 for processing. After processing, the processed packets are forward to destination VM 172. In the example, processed packets can be hairpinned to send out directly to the network without being forwarded to the NVA 171.

Referring to FIG. 1E, illustrated is an example flow through a NVA 171 from source VM 170 to destination VM 172. FIG. 1E illustrates an example where a first packet is routed to the NVA 171 for processing and then forwarded to the destination VM 172. The flow is offloaded to floating NIC 173. The flow table 175 at fNIC 173 is populated with the next hop physical address of the NVA 171 and match action X. In one example, the NVA or other user can cause a flow offload packet 177 to be sent to the IP of the fNIC 173. After the flow offload packet 177 is sent to the IP of the fNIC 173, the NVA 171 is bypassed by subsequent packets until the expiration of the flow. FIG. 1F illustrates that subsequent traffic is forwarded to the floating NIC 173 for processing using the flow table 175 which is populated with the next hop physical address of the destination VM 172 while the match action is unchanged. After processing, the processed packets are forwarded to destination VM 172. In the example, processed packets are sent out directly to the destination VM 172 without being forwarded to the NVA 171.

In one embodiment, the fNIC can operate in a flow offload mode, and provide flow cache as a service. In one implementation, the fNIC can be either attached to the VM or detached from the VM. The NVA or other source can send a flow offload packet to the IP address of the fNIC. After the flow offload packet is received by the fNIC and the fNIC assumes processing of the offloaded flow, the NVA VM is bypassed for subsequent packets until expiration of the flow. In one embodiment, the flow can have a TTL. When the TTL for the flow expires, the flow can be removed from the VM and the fNIC.

In various embodiments, routing and tunneling can be offloaded. In this example, routing/tunneling can be offloaded to the fNIC. In some cases, flow actions do not need to change, and the physical address can be changed. After the fNIC receives a flow offload packet, the fNIC will bypass the NVA next hop for that flow. Depending on the particular implementation of the NVA, the flow patch packet will have the customer address (CA) and not the PA.

The disaggregation techniques described herein allow for the offload of selected flows from the network virtual appliance to an acceleration device such as an fNIC. Selected flows can be offloaded to the acceleration device to process SDN data path rules and transformations in a manner that is further disaggregated such that packets of offloaded flows can be processed without having the packets delivered to a network virtual appliance which previously performed the packet processing.

In some embodiments, the network virtual appliance or another source or user can select a flag, send a packet, or employ some other mechanism to move the SDN data path rule and transformation processing for a given flow from the network virtual appliance to the acceleration device. In some embodiments, the use of a packet to move the SDN data path rule and transformation processing can be performed using a flow offload packet. By pushing data flows being processed by a network virtual appliance to the acceleration device in this manner, the network virtual appliance continues to process SDN workloads while a portion of the workloads are re-directed to the acceleration device. This can be a cost-effective way to increase the capabilities of a network virtual appliance because only a portion of workloads are processed in the network virtual appliance.

The present disclosure thus provides a way to optimize the use of the SDN infrastructure with an acceleration device. In an embodiment, a user, VM, SDN appliance, or the network virtual appliance can flag the need for this capability. In some embodiments, the system can detect the need for the offload dynamically using thresholds or other mechanisms.

The content of a flow offload packet can include inner flow 5 tuples: SRC, DST, SRC Port, DST Port, Protocol, and a Routing Action (e.g., Encapsulation with SRC IP, DST IP). As mentioned, the flow offload packet can be a FastpPath++packet. The acceleration device is configured to create a full data flow based on this match action information and process the flow locally without the need for the network virtual appliance to touch subsequent data packets. The acceleration device can further send additional flow offload packets to terminate processing of a flow, or the acceleration device can use the age of the flow to determine when to stop or remove an offloaded flow. In some cases the NVA can limit the time that a flow is offloaded to the fNIC. In some embodiments, the NVA can send a request to terminate processing of the offloaded flow by the fNIC, and the NVA can assume processing of the remainder of the flow, terminate the flow, etc.

The present disclosure thus enables offload of selected packet flows and other functions to an acceleration device such as a floating NIC. This offloading thus enables the packets of an offloaded flow to be processed and forwarded to their destination without having to be delivered first to an intermediate destination for packet processing. Offloading of packet processing to the floating NIC enables selected flows to be processed in the network (via the floating NIC) which has higher network bandwidth as compared to the network virtual appliance.

In an embodiment, the floating NICs have the ability to support a flow offload protocol from a network virtual appliance, so that there is no SDN policy storage needed on the floating NICs. The network virtual appliance will send a flow offload packet, which contains matches and actions and other instructions. The floating NICs can create the full flow based on this match action and stop forwarding that 5 tuple to the network virtual appliance for processing.

The following illustrates example content of a flow offload Packet:
Flow 5 tuple: SRC, DST, SRC Port, DST port, Protocol
Routing Action
High Level Flow patch packet content
GENEVE header
Special key
An opcode indicating that this is CA flow patch
Flow patch action (can be a next hop patch).
Expire flow after TTL

In an embodiment, the floating NICs have sufficient memory to hold a specified number of flows. Additionally, the floating NICs can be configured to define and handle flow aging and flow purge.

In various embodiments, if a performance threshold is reached on the host or network virtual appliance, such as a bandwidth threshold, the host or network virtual appliance can request an SDN controller or other management function to apply SDN rules for a given flow to the floating NIC and cause the floating NIC to be the preferred route on the way to the destination. In another embodiment, the network virtual appliance itself can initiate and perform the offload without the need to invoke a management function. This process can include the network virtual appliance parsing and identifying the rules and policies that are applicable to the destination and initiating a process to synchronize the associated connections from the destination (or the server hosting the destination) to the floating NIC. In one embodiment, packets can be directed to the floating NIC for application of the rules and policies. For example, the routing can be achieved by updating the next hop IP address of the tunnel set up for the communication to the destination. Once the tunnel rule is updated, any new connections will start to flow through the floating NIC. Before updating the tunnel rules, the connection manager or other function can perform a synchronization process to ensure that the floating NIC is capable of handling both established and any new connections. Assuming the floating NIC is preferred over the network virtual appliance, the number of new connections can be reduced for a short period of time so that the overhead of dynamically synchronizing new connections is low.

In one embodiment, an example sequence in accordance with the disclosed embodiments is as follows:

A performance or table threshold is reached.

A request is sent to move an SDN data path to the floating NIC.

Policies of the associated VM or destination are updated to the floating NIC. In an embodiment, an SDN policy enforcement/forwarding engine can manage connections generally.

The floating NIC performs a synchronization to the network virtual appliance.

Once synchronization is complete, the tunnel route on the destination (e.g., VM host) is updated to bypass the network virtual appliance for the given flow.

The floating NIC will process any packets for the connection as they arrive.

All packets for the workload will no longer flow to the network virtual appliance.

The network virtual appliance will be able to remove the connection as it is not flowing through the tunnel between itself and the destination, freeing up resources on the network virtual appliance.

After this sequence is complete, processing and forwarding is performed by the floating NIC with higher network performance.

More generally, the NVA can offload any connection type that the floating NIC has been programmed to handle and is within its capabilities. For example, the NVA may operate up to Layer-7 and expect that the floating NIC establish connections up to Layer-7 as well. Although the examples herein include implementations that operate at the connection layer, the described fast path offload may operate up to the application layer or Layer-7. Thus in one example, the NVA can offload Layer-4 connections to the floating NIC and forward Layer-7 connections itself. Alternatively, the NVA can offload both Layer-4 connections and Layer-7 connections to the floating NIC if the floating NIC is configured to provide entries for both Layer-4 and Layer-7 connections.

The described process can move connections between the network virtual appliance and the floating NIC in the reverse direction. This can take place, for example, in response to determining that a threshold is no longer being met or otherwise that the performance provided by floating NIC offloading is no longer needed. Returning a connection to the network virtual appliance allows the network virtual appliance and SDN overall to be optimally utilized and leads to less overall overhead while optimally maintaining the level of performance provided to the SDN network in general.

The floating NIC can be more optimally utilized as connection processing can be dynamically moved between the floating NIC and the network virtual appliance based on various thresholds such as bandwidth, connections per second (CPS), etc. This avoids the use of the floating NIC for high bandwidth needs that are no longer needed, or for network virtual appliances that only need the performance of the floating NIC on an infrequent basis.

As used herein, a device that is configured to track connections in a software defined network (SDN) may include network devices, appliances, switches, and other devices that are implemented for processing packets in SDNs and other architectures that require processing of packets that are associated with various sessions and connections. Such devices may also be referred to as an accelerator device. For example, with reference to FIG. 1A, illustrated is an example architecture illustrating packet processing according to the disclosed embodiments. In one example, a data packet 110 in a data flow may be received via a sNIC 160. Packet 110 may be identified and sent to NVA 113. NVA 113 may have a processing engine that is configured to manage processing of data flows. In some embodiments, the processing engine runs on host server 111. In some embodiments, the sNIC 160 can be part of an SDN appliance or other complex that includes smart NICs, a DPU appliance, and the like.

Initial or slow path connections may be performed by the NVA 113. With reference to FIG. 1B, NVA 113 may offload processing of packets of a flow to the sNIC 160 rather than at NVA 113.

In an example, FIGS. 1A and 1B illustrate an example of managing connections or bidirectional flows of a communication session in a software defined network (SDN) comprising a host server 111 hosting a NVA 113. The SDN further comprises an sNIC 160. In some embodiments, sNIC 160 can be remote or can be part of an appliance hosting a plurality of sNICs. As used herein, hosts can also be referred to as computing nodes which can be physical or virtual computing devices having a physical or virtual processor and memory.

Session information 131 for the communication session is stored in a connection record. FIG. 1B illustrates that flow offload packet 125 is sent to cause offload of packet processing to the sNIC 160. The flow offload packet 125 indicates that rules applicable to the packet 110 and session 131 should be processed by sNIC 160. In various embodiments, the flow offload packet 125 can originate from various components depending on the particular implementation. sNIC 160 parses the rules 154 and performs a synchronization of rules that are applicable to packet 110 and session 131. In an embodiment, the rules can be provided in offload packet 125. As a result, subsequent data packets 110 that are part of session 131 will be processed by sNIC 160.

In an example, the flow offload packet 125 can be sent to sNIC 160 when it is determined that the communication session associated with packet 110 meets a threshold 128 for offloading application of rules for the communication session associated with packet 110 to sNIC 160. The flow offload packet 125 indicates that rules applicable to the data packet 110 should be processed by sNIC 160.

In an embodiment, FIGS. 1A and 1B illustrate an example of how data flows are managed in a software defined network (SDN) comprising a plurality of computing nodes and a hardware-based network interface device. The plurality of computing nodes may host a plurality of virtual machines and a network virtual appliance. The sNIC 160 can be referred to as a hardware-based network interface device. The sNIC 160 receives a first data packet of a data flow described by session information 131 addressed to an endpoint hosted on one of the plurality of virtual machines of the SDN. The sNIC 160 forwards the first data packet 110 to the network virtual appliance 113. The network virtual appliance 113 processes the first data packet according to a match action associated with the data flow. The network virtual appliance 113 forwards to the sNIC 160 the processed data packet for routing to the endpoint. The network virtual appliance 113 sends to the sNIC 160 a request (offload packet) 125 to offload processing of subsequent packets 110 of the data flow in accordance with the match action associated with the data flow. Based on content of the request 125, the sNIC 160 generates or copies or stores session information 131 associated with the data flow. The session information 131 enables offloading of processing of the subsequent data packets 110 associated with the data flow from the network virtual appliance 113 to the sNIC 160. The sNIC 160 applies the match action associated with the data flow to the subsequent data packets 110. The application of the match action is disaggregated from physical dependencies on a computing node (e.g., host server 111) that is hosting the network virtual appliance 113. The sNIC 160 forwards the processed subsequent data packets to the endpoint. This enables the subsequent data packets to be processed and forwarded by the sNIC 160 without being forwarded to or processed by the network virtual appliance 113.

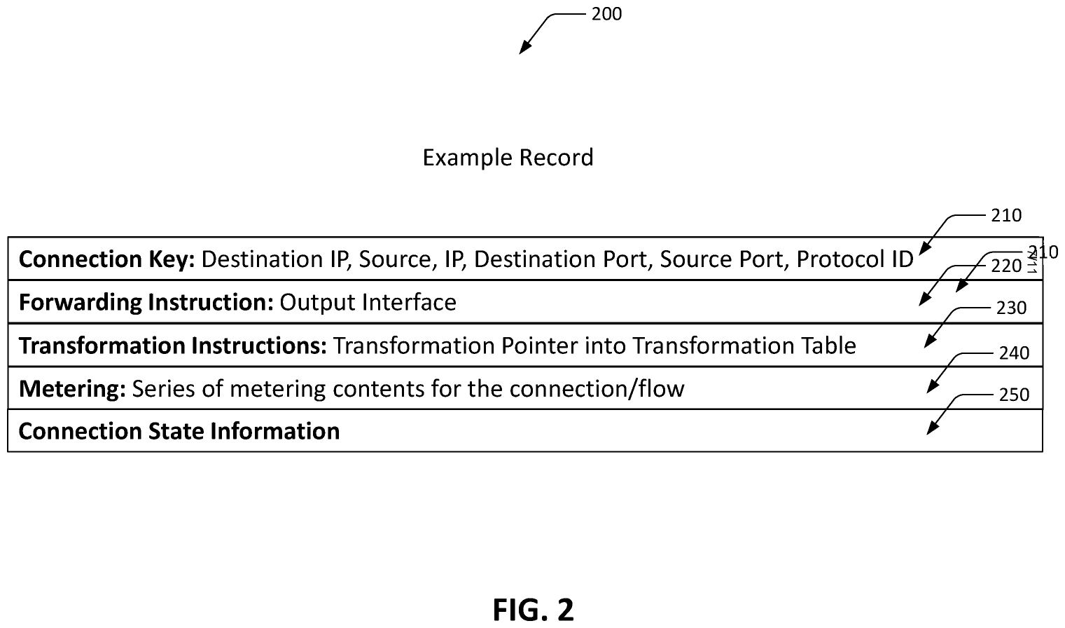

FIG. 2 illustrates an example record of a fast path connection table 200. Connection table 200 illustrates an entry for a connection key 210 that includes a Destination IP, Source IP, Destination Port, Source Port, and Protocol ID. Forwarding Instruction 220 may include, for example, an Output Interface that may indicate where the packet needs to go, such as identify an interface at a network interface card (NIC). Transformation Instructions 230 may include a Transformation Pointer into the Transformation Table. The instructions may indicate the transformations identified for packets in the flow such as applying a tunnel on it, changes of source or destination addresses, new filters, etc. Metering 240 may include a series of metering contents for the connection/flow. Metering may allow for charging based on usage, for example.

The Connection Key 210 may be a constant for the duration of the record. The Forwarding Instruction 220 output interface can be updated by the SDN control plane via re-simulation. Transformation Instructions 230 can be updated by the SDN control plane via-re-simulation. Metering 240 may be valid while the record is constant or aggregated and sent upwards if the record is changed. Connection state information 250 includes various information needed for each connection or flow.

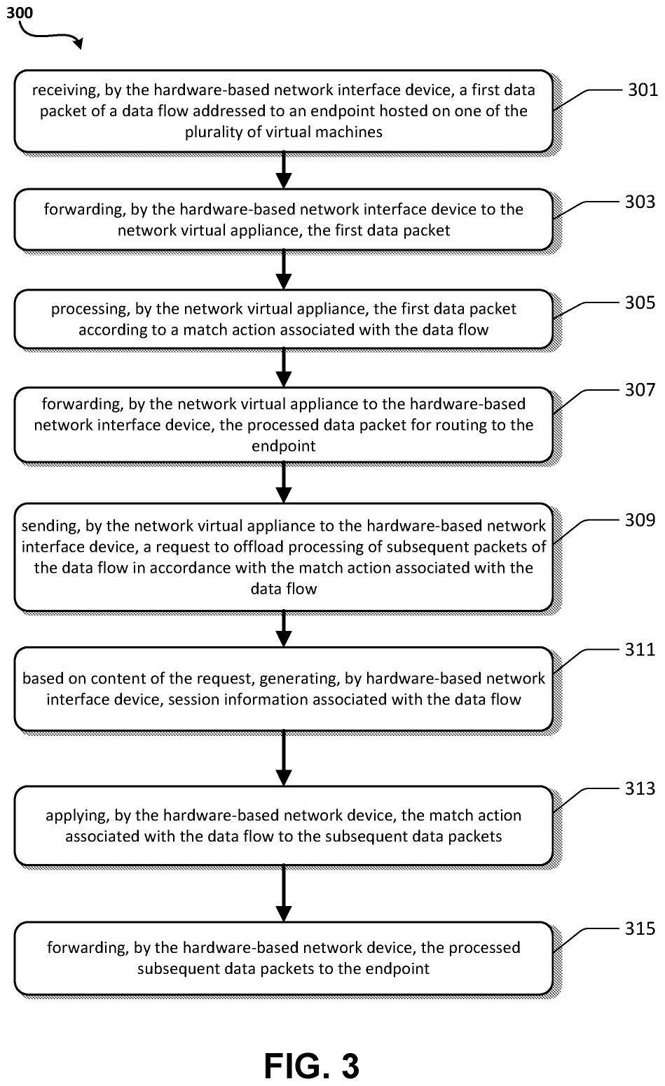

Turning now to FIG. 3, illustrated is an example operational procedure for managing data flows in a software defined network (SDN) comprising a plurality of computing nodes and a hardware-based network interface device, the plurality of computing nodes hosting a plurality of virtual machines and a network virtual appliance.

Such an operational procedure can be provided by one or more components illustrated in FIGS. 1A through 1F. The operational procedure may be implemented in a system comprising one or more computing devices. It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It should also be understood that the illustrated methods can end at any time and need not be performed in their entireties. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

It should be appreciated that the logical operations described herein are implemented (1) as a sequence of computer implemented acts or program modules running on a computing system such as those described herein) and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof. Thus, although the routine 300 is described as running on a system, it can be appreciated that the routine 300 and other operations described herein can be executed on an individual computing device or several devices.

Referring to FIG. 3, operation 301 illustrates receiving, by the hardware-based network interface device, a first data packet of a data flow addressed to an endpoint hosted on one of the plurality of virtual machines.

Operation 303 illustrates forwarding, by the hardware-based network interface device to the network virtual appliance, the first data packet.

Operation 305 illustrates processing, by the network virtual appliance, the first data packet according to a match action associated with the data flow.

Operation 307 illustrates forwarding, by the network virtual appliance to the hardware-based network interface device, the processed data packet for routing to the endpoint.

Operation 309 illustrates sending, by the network virtual appliance to the hardware-based network interface device, a request to offload processing of subsequent packets of the data flow in accordance with the match action associated with the data flow.

Operation 311 illustrates based on content of the request, generating, by hardware-based network interface device, session information associated with the data flow, wherein the session information enables offloading of processing of the subsequent data packets associated with the data flow from the network virtual appliance to the hardware-based network interface device.

Operation 313 illustrates applying, by the hardware-based network device, the match action associated with the data flow to the subsequent data packets, wherein the application of the match action is disaggregated from physical dependencies on a computing node that is hosting the network virtual appliance.

Operation 315 illustrates forwarding, by the hardware-based network device, the processed subsequent data packets to the endpoint, thereby enabling the subsequent data packets to be processed and forwarded by the hardware-based network device without being forwarded to or processed by the network virtual appliance.

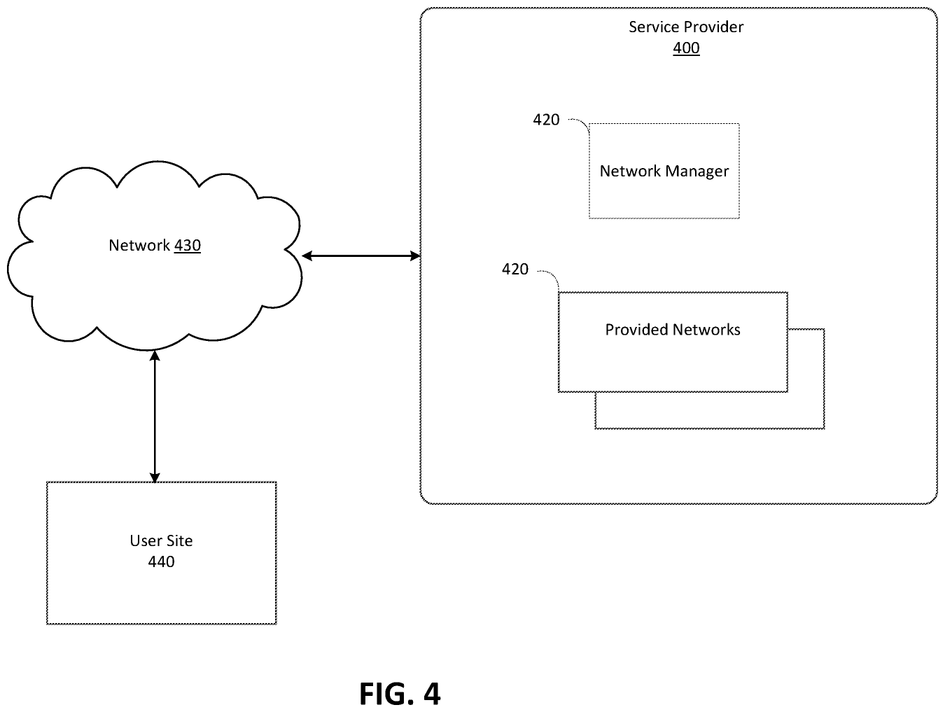

FIG. 4 illustrates an example computing environment in which the embodiments described herein may be implemented. FIG. 4 illustrates a service provider 400 that is configured to provide computing resources and provided networks 420 to users at user site 440. The user site 440 may have user computers that may access services provided by service provider 400 via a network 430. The computing resources provided by the service provider 400 may include various types of resources, such as computing resources, data storage resources, data communication resources, and the like. For example, computing resources may be available as virtual machines. The virtual machines may be configured to execute applications, including Web servers, application servers, media servers, database servers, and the like. Data storage resources may include file storage devices, block storage devices, and the like. Networking resources may include virtual networking, software load balancer, and the like.

Service provider 400 may have various computing resources including servers, routers, and other devices that may provide remotely accessible computing and network resources using, for example, virtual machines. Other resources that may be provided include data storage resources. Service provider 400 may also execute functions that manage and control allocation of network resources, such as a network manager 420.

Network 430 may, for example, be a publicly accessible network of linked networks and may be operated by various entities, such as the Internet. In other embodiments, network 430 may be a private network, such as a dedicated network that is wholly or partially inaccessible to the public. Network 430 may provide access to computers and other devices at the user site 440.

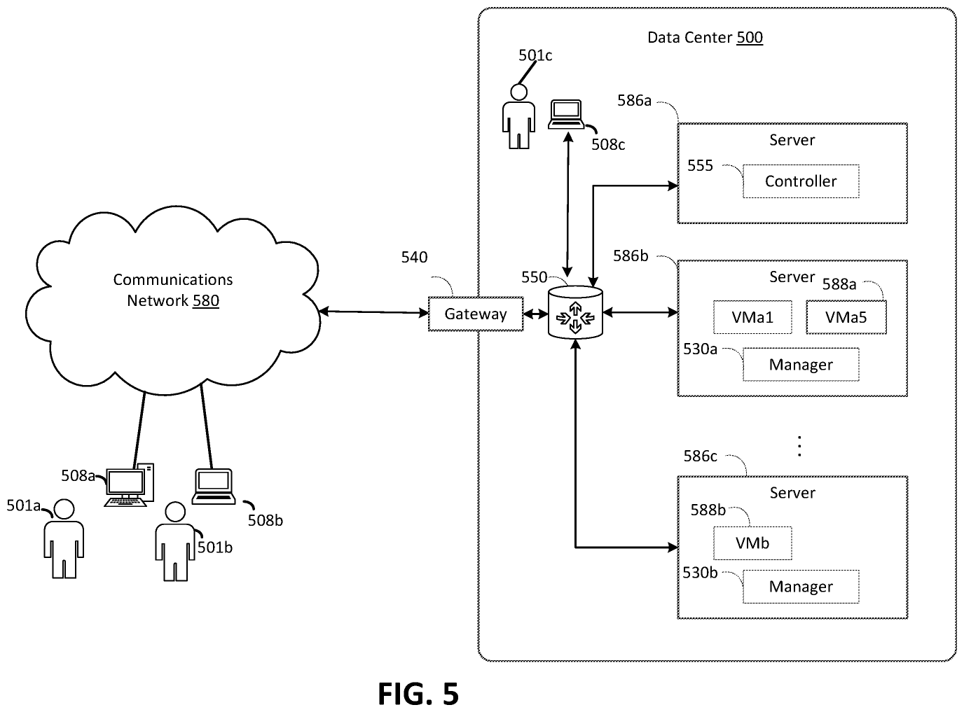

FIG. 5 illustrates an example computing environment in which the embodiments described herein may be implemented. FIG. 5 illustrates a data center 500 that is configured to provide computing resources to users 501a, 501b, or 501c (which may be referred herein singularly as “a user 501” or in the plural as “the users 501”) via user computers 508a,508b, and 508c (which may be referred herein singularly as “a computer 508” or in the plural as “the computers 508”) via a communications network 580. The computing resources provided by the data center 500 may include various types of resources, such as computing resources, data storage resources, data communication resources, and the like. Each type of computing resource may be general-purpose or may be available in a number of specific configurations. For example, computing resources may be available as virtual machines. The virtual machines may be configured to execute applications, including Web servers, application servers, media servers, database servers, and the like. Data storage resources may include file storage devices, block storage devices, and the like. Each type or configuration of computing resource may be available in different configurations, such as the number of processors, and size of memory and/or storage capacity. The resources may in some embodiments be offered to clients in units referred to as instances, such as virtual machine instances or storage instances. A virtual computing instance may be referred to as a virtual machine and may, for example, comprise one or more servers with a specified computational capacity (which may be specified by indicating the type and number of CPUs, the main memory size and so on) and a specified software stack (e.g., a particular version of an operating system, which may in turn run on top of a hypervisor).

Data center 500 may include servers 586a, 586b, and 586c (which may be referred to herein singularly as “a server 586” or in the plural as “the servers 586”) that may be standalone or installed in server racks, and provide computing resources available as virtual machines 588a and 588b (which may be referred to herein singularly as “a virtual machine 588” or in the plural as “the virtual machines 588”). The virtual machines 588 may be configured to execute applications such as Web servers, application servers, media servers, database servers, and the like. Other resources that may be provided include data storage resources (not shown on FIG. 5) and may include file storage devices, block storage devices, and the like. Servers 586 may also execute functions that manage and control allocation of resources in the data center, such as a controller 555. Controller 555 may be a fabric controller or another type of program configured to manage the allocation of virtual machines on servers 586.

Referring to FIG. 5, communications network 580 may, for example, be a publicly accessible network of linked networks and may be operated by various entities, such as the Internet. In other embodiments, communications network 580 may be a private network, such as a corporate network that is wholly or partially inaccessible to the public.

Communications network 580 may provide access to computers 508. Computers 508 may be computers utilized by users 501. Computer 508a, 508b or 508c may be a server, a desktop or laptop personal computer, a tablet computer, a smartphone, a set-top box, or any other computing device capable of accessing data center 500. User computer 508a or 508b may connect directly to the Internet (e.g., via a cable modem). User computer 508c may be internal to the data center 500 and may connect directly to the resources in the data center 500 via internal networks. Although only three user computers 508a,508b, and 508c are depicted, it should be appreciated that there may be multiple user computers.

Computers 508 may also be utilized to configure aspects of the computing resources provided by data center 500. For example, data center 500 may provide a Web interface through which aspects of its operation may be configured through the use of a Web browser application program executing on user computer 508. Alternatively, a stand-alone application program executing on user computer 508 may be used to access an application programming interface (API) exposed by data center 500 for performing the configuration operations.

Servers 586 may be configured to provide the computing resources described above. One or more of the servers 586 may be configured to execute a manager 530a or 530b (which may be referred herein singularly as “a manager 530” or in the plural as “the managers 530”) configured to execute the virtual machines. The managers 530 may be a virtual machine monitor (VMM), fabric controller, or another type of program configured to enable the execution of virtual machines 588 on servers 586, for example.

It should be appreciated that although the embodiments disclosed above are discussed in the context of virtual machines, other types of implementations can be utilized with the concepts and technologies disclosed herein.

In the example data center 500 shown in FIG. 5, a network device 550 may be utilized to interconnect the servers 586a and 586b. Network device 550 may comprise one or more switches, routers, or other network devices. Network device 550 may also be connected to gateway 540, which is connected to communications network 580. Network device 550 may facilitate communications within networks in data center 500, for example, by forwarding packets or other data communications as appropriate based on characteristics of such communications (e.g., header information including source and/or destination addresses, protocol identifiers, etc.) and/or the characteristics of the private network (e.g., routes based on network topology, etc.). It will be appreciated that, for the sake of simplicity, various aspects of the computing systems and other devices of this example are illustrated without showing certain conventional details. Additional computing systems and other devices may be interconnected in other embodiments and may be interconnected in different ways.

It should be appreciated that the network topology illustrated in FIG. 5 has been greatly simplified and that many more networks and networking devices may be utilized to interconnect the various computing systems disclosed herein. These network topologies and devices should be apparent to those skilled in the art.

It should also be appreciated that data center 500 described in FIG. 5 is merely illustrative and that other implementations might be utilized. Additionally, it should be appreciated that the functionality disclosed herein might be implemented in software, hardware or a combination of software and hardware. Other implementations should be apparent to those skilled in the art. It should also be appreciated that a server, gateway, or other computing device may comprise any combination of hardware or software that can interact and perform the described types of functionality, including without limitation desktop or other computers, database servers, network storage devices and other network devices, PDAs, tablets, smartphone, Internet appliances, television-based systems (e.g., using set top boxes and/or personal/digital video recorders), and various other consumer products that include appropriate communication capabilities. In addition, the functionality provided by the illustrated modules may in some embodiments be combined in fewer modules or distributed in additional modules. Similarly, in some embodiments the functionality of some of the illustrated modules may not be provided and/or other additional functionality may be available.

In some embodiments, aspects of the present disclosure may be implemented in a mobile edge computing (MEC) environment implemented in conjunction with a 4G, 5G, or other cellular network. MEC is a type of edge computing that uses cellular networks and 5G and enables a data center to extend cloud services to local deployments using a distributed architecture that provide federated options for local and remote data and control management. MEC architectures may be implemented at cellular base stations or other edge nodes and enable operators to host content closer to the edge of the network, delivering high-bandwidth, low-latency applications to end users. For example, the cloud provider's footprint may be co-located at a carrier site (e.g., carrier data center), allowing for the edge infrastructure and applications to run closer to the end user via the 5G network.

The various aspects of the disclosure are described herein with regard to certain examples and embodiments, which are intended to illustrate but not to limit the disclosure. It should be appreciated that the subject matter presented herein may be implemented as a computer process, a computer-controlled apparatus, a computing system, an article of manufacture, such as a computer-readable storage medium, or a component including hardware logic for implementing functions, such as a field-programmable gate array (FPGA) device, a massively parallel processor array (MPPA) device, a graphics processing unit (GPU), an application-specific integrated circuit (ASIC), a multiprocessor System-on-Chip (MPSoC), etc.

A component may also encompass other ways of leveraging a device to perform a function, such as, for example, a case in which at least some tasks are implemented in hard ASIC logic or the like, or a case in which at least some tasks are implemented in soft (configurable) logic or the like, a case in which at least some tasks run as software on software processor overlays or the like; a case in which at least some tasks run as software on hard ASIC processors or the like, etc., or any combination thereof. A component may represent a homogeneous collection of hardware acceleration devices. On the other hand, a component may represent a heterogeneous collection of different types of hardware acceleration devices including different types of devices having different respective processing capabilities and architectures, a mixture of devices and other types hardware acceleration devices, etc.

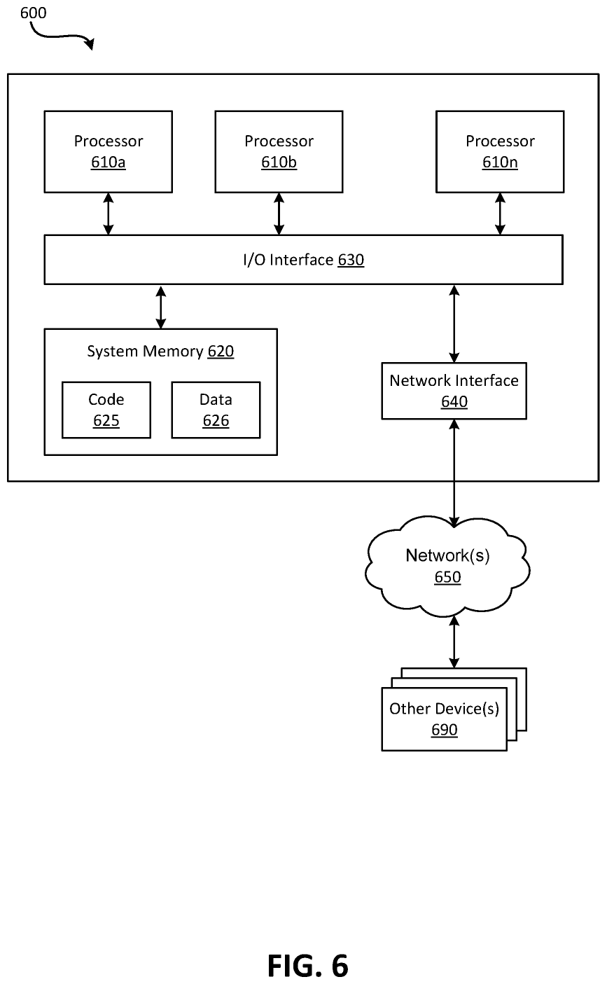

FIG. 6 illustrates a general-purpose computing device 600. In the illustrated embodiment, computing device 600 includes one or more processors 610a, 610b, and/or 610n (which may be referred herein singularly as “a processor 610” or in the plural as “the processors 610”) coupled to a system memory 620 via an input/output (I/O) interface 630. Computing device 600 further includes a network interface 640 coupled to I/O interface 630.

In various embodiments, computing device 600 may be a uniprocessor system including one processor 610 or a multiprocessor system including several processors 610 (e.g., two, four, eight, or another suitable number). Processors 610 may be any suitable processors capable of executing instructions. For example, in various embodiments, processors 610 may be general-purpose or embedded processors implementing any of a variety of instruction set architectures (ISAs), such as the x66, PowerPC, SPARC, or MIPS ISAs, or any other suitable ISA. In multiprocessor systems, each of processors 610 may commonly, but not necessarily, implement the same ISA.

System memory 620 may be configured to store instructions and data accessible by processor(s) 610. In various embodiments, system memory 620 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing one or more desired functions, such as those methods, techniques and data described above, are shown stored within system memory 620 as code 625 and data 626.

In one embodiment, I/O interface 630 may be configured to coordinate I/O traffic between the processor 610, system memory 620, and any peripheral devices in the device, including network interface 640 or other peripheral interfaces. In some embodiments, I/O interface 630 may perform any necessary protocol, timing, or other data transformations to convert data signals from one component (e.g., system memory 620) into a format suitable for use by another component (e.g., processor 610). In some embodiments, I/O interface 630 may include support for devices attached through various types of peripheral buses, such as a variant of the Peripheral Component Interconnect (PCI) bus standard or the Universal Serial Bus (USB) standard, for example. In some embodiments, the function of I/O interface 630 may be split into two or more separate components. Also, in some embodiments some or all of the functionality of I/O interface 630, such as an interface to system memory 620, may be incorporated directly into processor 610.

Network interface 640 may be configured to allow data to be exchanged between computing device 600 and other device or devices 690 attached to a network or network(s) 650, such as other computer systems or devices as illustrated in FIGS. 1 through 5, for example. In various embodiments, network interface 640 may support communication via any suitable wired or wireless general data networks, such as types of Ethernet networks, for example. Additionally, network interface 640 may support communication via telecommunications/telephony networks such as analog voice networks or digital fiber communications networks, via storage area networks such as Fibre Channel SANs or via any other suitable type of network and/or protocol.

In some embodiments, system memory 620 may be one embodiment of a computer-accessible medium configured to store program instructions and data as described above for the Figures for implementing embodiments of the corresponding methods and apparatus. However, in other embodiments, program instructions and/or data may be received, sent or stored upon different types of computer-accessible media. A computer-accessible medium may include non-transitory storage media or memory media, such as magnetic or optical media, e.g., disk or DVD/CD coupled to computing device 600 via I/O interface 630. A non-transitory computer-accessible storage medium may also include any volatile or non-volatile media, such as RAM (e.g. SDRAM, DDR SDRAM, RDRAM, SRAM, etc.), ROM, etc., that may be included in some embodiments of computing device 600 as system memory 620 or another type of memory. Further, a computer-accessible medium may include transmission media or signals such as electrical, electromagnetic or digital signals, conveyed via a communication medium such as a network and/or a wireless link, such as may be implemented via network interface 640. Portions or all of multiple computing devices, such as those illustrated in FIG. 6, may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computing device,” as used herein, refers to at least all these types of devices and is not limited to these types of devices.

Various storage devices and their associated computer-readable media provide non-volatile storage for the computing devices described herein. Computer-readable media as discussed herein may refer to a mass storage device, such as a solid-state drive, a hard disk or CD-ROM drive. However, it should be appreciated by those skilled in the art that computer-readable media can be any available computer storage media that can be accessed by a computing device.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computing devices discussed herein. For purposes of the claims, the phrase “computer storage medium,” “computer-readable storage medium” and variations thereof, does not include waves, signals, and/or other transitory and/or intangible communication media, per se.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the disclosed computing devices in order to store and execute the software components and/or functionality presented herein. It is also contemplated that the disclosed computing devices may not include all of the illustrated components shown in FIG. 6, may include other components that are not explicitly shown in FIG. 6, or may utilize an architecture completely different than that shown in FIG. 6.

Although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without author input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be appreciated any reference to “first,” “second,” etc. items and/or abstract concepts within the description is not intended to and should not be construed to necessarily correspond to any reference of “first,” “second,” etc. elements of the claims. In particular, within this Summary and/or the following Detailed Description, items and/or abstract concepts such as, for example, individual computing devices and/or operational states of the computing cluster may be distinguished by numerical designations without such designations corresponding to the claims or even other paragraphs of the Summary and/or Detailed Description. For example, any designation of a “first operational state” and “second operational state” of the computing cluster within a paragraph of this disclosure is used solely to distinguish two different operational states of the computing cluster within that specific paragraph-not any other paragraph and particularly not the claims.

Although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

The disclosure presented herein also encompasses the subject matter set forth in the following clauses:

Clause 1: A method for managing data flows in a software defined network (SDN) comprising a plurality of computing nodes and a hardware-based network interface device, the plurality of computing nodes hosting a plurality of virtual machines and a network virtual appliance, the method comprising:
receiving, by the hardware-based network interface device, a first data packet of a data flow addressed to an endpoint hosted on one of the plurality of virtual machines;
forwarding, by the hardware-based network interface device to the network virtual appliance, the first data packet;
processing, by the network virtual appliance, the first data packet according to a match action associated with the data flow;
forwarding, by the network virtual appliance to the hardware-based network interface device, the processed data packet for routing to the endpoint;
sending, by the network virtual appliance to the hardware-based network interface device, a request to offload processing of subsequent packets of the data flow in accordance with the match action associated with the data flow;
based on content of the request, generating, by hardware-based network interface device, session information associated with the data flow, wherein the session information enables offloading of processing of the subsequent data packets associated with the data flow from the network virtual appliance to the hardware-based network interface device;
applying, by the hardware-based network device, the match action associated with the data flow to the subsequent data packets, wherein the application of the match action is disaggregated from physical dependencies on a computing node that is hosting the network virtual appliance; and
forwarding, by the hardware-based network device, the processed subsequent data packets to the endpoint, thereby enabling the subsequent data packets to be processed and forwarded by the hardware-based network device without being forwarded to or processed by the network virtual appliance.

Clause 2: The method of clause 1, wherein the request comprises a flow offload packet that includes matches and actions.

Clause 3: The method of any of clauses 1-2, wherein the hardware-based network device is configured to generate the data flow based on the matches and actions and process the data flow to be offloaded from the network virtual appliance to the hardware-based network device without forwarding packets associated with the data flow to the network virtual appliance.

Clause 4: The method of any of clauses 1-3, wherein the matches and actions include encapsulation with a SRC IP or DST IP.

Clause 5: The method of any of clauses 1-4, further comprising sending an additional request to terminate processing of the data flow.

Clause 6: The method of any of clauses 1-5, wherein the hardware-based network device is configured to use an age of the data flow to determine when to stop or remove processing of the data flow.

Clause 7: The method of any of clauses 1-6, wherein the hardware-based network device is configured to terminate processing of the data flow in response to expiration of a TTL.

Clause 8: The method of any of clauses 1-7, wherein the data flow is offloaded when the data flow meets a bandwidth threshold.

Clause 9: The method of any of clauses 1-8, wherein the generating the session information comprises parsing a plurality of rules to identify rules that are applicable to a source or destination of the data flow.

Clause 10: The method of any of clauses 1-9, further comprising returning processing of the subsequent packets of the data flow from the hardware-based network device to the network virtual appliance.

Clause 11: The method of any of clauses 1-10, wherein the returning is performed in response to determining that the data flow no longer meets a criterion for offloading processing of packets of the data flow to the hardware-based network device.

Clause 12: A system for data flows in a software defined network (SDN), the system comprising a plurality of computing nodes hosting a plurality of virtual machines and a network virtual appliance, the system further comprising a hardware-based network interface device, the system configured to perform operations comprising:
receiving, by the hardware-based network interface device, a first data packet of a data flow addressed to an endpoint hosted on one of the plurality of virtual machines;
forwarding, by the hardware-based network interface device to the network virtual appliance, the first data packet;
processing, by the network virtual appliance, the first data packet according to a match action associated with the data flow;
forwarding, by the network virtual appliance to the hardware-based network interface device, the processed data packet for routing to the endpoint;
sending, by the network virtual appliance to the hardware-based network interface device, a request to offload processing of subsequent packets of the data flow in accordance with the match action associated with the data flow;
based on content of the request, generating, by hardware-based network interface device, session information associated with the data flow, wherein the session information enables offloading of processing of the subsequent data packets associated with the data flow from the network virtual appliance to the hardware-based network interface device;
applying, by the hardware-based network device, the match action associated with the data flow to the subsequent data packets, wherein the application of the match action is disaggregated from physical dependencies on a computing node that is hosting the network virtual appliance; and
forwarding, by the hardware-based network device, the processed subsequent data packets to the endpoint, thereby enabling the subsequent data packets to be processed and forwarded by the hardware-based network device without being forwarded to or processed by the network virtual appliance.

Clause 13: The system of clause 12, wherein the request comprises a FastPath++ packet that includes matches and actions for the data flow.

Clause 14: The system of any of clauses 12 and 13, wherein the hardware-based network device is configured to generate the session information for the data flow based on the matches and actions and process packets of the data flow without forwarding packets associated with the data flow to the network virtual appliance.

Clause 15: The system of any of clauses 12-14, further comprising sending an additional request to terminate processing of the data flow.

Clause 16: The system of any of clauses 12-15, wherein the hardware-based network device is configured to use an age of the data flow to determine when to stop or remove processing of packets of the data flow.

Clause 17: The system of any of clauses 12-16, wherein the hardware-based network device is configured to terminate processing of packets of the data flow in response to expiration of a TTL.

Clause 18: The system of any of clauses 12-17, wherein the generation of the session information comprises parsing a plurality of rules to identify rules that are applicable to a source or destination of the data flow.

Clause 19: The system of any of clauses 12-18, further comprising returning processing of packets of the data flow from the hardware-based network device to the network virtual appliance.

Clause 20: A hardware-based network interface device configured to perform operations comprising:
forwarding, to a network virtual appliance, a first data packet of a data flow addressed to an endpoint hosted on one of a plurality of virtual machines;
receiving, from the network virtual appliance, a request to offload processing of subsequent packets of the data flow in accordance with a match action associated with the data flow;
based on content of the request, generating session information associated with the data flow, wherein the session information enables offloading of processing of the subsequent data packets associated with the data flow from the network virtual appliance to the hardware-based network interface device;
applying the match action associated with the data flow to the subsequent data packets, wherein the application of the match action is disaggregated from physical dependencies on a computing node that is hosting the network virtual appliance; and
forwarding the processed subsequent data packets to the endpoint, thereby enabling the subsequent data packets to be processed by the hardware-based network device without being forwarded to or processed by the network virtual appliance.

What is claimed is:

1. A method for managing data flows in a software defined network (SDN) comprising a plurality of computing nodes and a hardware-based network interface device, the plurality of computing nodes hosting a plurality of virtual machines and a network virtual appliance, the method comprising:
receiving, by the hardware-based network interface device, a first data packet of a data flow addressed to an endpoint hosted on one of the plurality of virtual machines;
forwarding, by the hardware-based network interface device to the network virtual appliance, the first data packet;
processing, by the network virtual appliance, the first data packet according to a match action associated with the data flow;
forwarding, by the network virtual appliance to the hardware-based network interface device, the processed data packet for routing to the endpoint;
sending, by the network virtual appliance to the hardware-based network interface device, a request to offload processing of subsequent packets of the data flow in accordance with the match action associated with the data flow;
based on content of the request, generating, by hardware-based network interface device, session information associated with the data flow, wherein the session information enables offloading of processing of the subsequent data packets associated with the data flow from the network virtual appliance to the hardware-based network interface device;
applying, by the hardware-based network device, the match action associated with the data flow to the subsequent data packets, wherein the application of the match action is disaggregated from physical dependencies on a computing node that is hosting the network virtual appliance; and
forwarding, by the hardware-based network device, the processed subsequent data packets to the endpoint, thereby enabling the subsequent data packets to be processed and forwarded by the hardware-based network device without being forwarded to or processed by the network virtual appliance.

2. The method of claim 1, wherein the request comprises a flow offload packet that includes matches and actions.

3. The method of claim 2, wherein the hardware-based network device is configured to generate the data flow based on the matches and actions and process the data flow to be offloaded from the network virtual appliance to the hardware-based network device without forwarding packets associated with the data flow to the network virtual appliance.

4. The method of claim 3, wherein the matches and actions include encapsulation with a SRC IP or DST IP.

5. The method of claim 1, further comprising sending an additional request to terminate processing of the data flow.

6. The method of claim 1, wherein the hardware-based network device is configured to use an age of the data flow to determine when to stop or remove processing of the data flow.

7. The method of claim 1, wherein the hardware-based network device is configured to terminate processing of the data flow in response to expiration of a TTL.

8. The method of claim 1, wherein the data flow is offloaded when the data flow meets a bandwidth threshold.

9. The method of claim 1, wherein the generating the session information comprises parsing a plurality of rules to identify rules that are applicable to a source or destination of the data flow.

10. The method of claim 1, further comprising returning processing of the subsequent packets of the data flow from the hardware-based network device to the network virtual appliance.

11. The method of claim 10, wherein the returning is performed in response to determining that the data flow no longer meets a criterion for offloading processing of packets of the data flow to the hardware-based network device.

12. A system for data flows in a software defined network (SDN), the system comprising a plurality of computing nodes hosting a plurality of virtual machines and a network virtual appliance, the system further comprising a hardware-based network interface device, the system configured to perform operations comprising:
receiving, by the hardware-based network interface device, a first data packet of a data flow addressed to an endpoint hosted on one of the plurality of virtual machines;
forwarding, by the hardware-based network interface device to the network virtual appliance, the first data packet;
processing, by the network virtual appliance, the first data packet according to a match action associated with the data flow;
forwarding, by the network virtual appliance to the hardware-based network interface device, the processed data packet for routing to the endpoint;
sending, by the network virtual appliance to the hardware-based network interface device, a request to offload processing of subsequent packets of the data flow in accordance with the match action associated with the data flow;
based on content of the request, generating, by hardware-based network interface device, session information associated with the data flow, wherein the session information enables offloading of processing of the subsequent data packets associated with the data flow from the network virtual appliance to the hardware-based network interface device;
applying, by the hardware-based network device, the match action associated with the data flow to the subsequent data packets, wherein the application of the match action is disaggregated from physical dependencies on a computing node that is hosting the network virtual appliance; and
forwarding, by the hardware-based network device, the processed subsequent data packets to the endpoint, thereby enabling the subsequent data packets to be processed and forwarded by the hardware-based network device without being forwarded to or processed by the network virtual appliance.

13. The system of claim 12, wherein the request comprises a FastPath++ packet that includes matches and actions for the data flow.

14. The system of claim 13, wherein the hardware-based network device is configured to generate the session information for the data flow based on the matches and actions and process packets of the data flow without forwarding packets associated with the data flow to the network virtual appliance.

15. The system of claim 12, further comprising sending an additional request to terminate processing of the data flow.

16. The system of claim 12, wherein the hardware-based network device is configured to use an age of the data flow to determine when to stop or remove processing of packets of the data flow.

17. The system of claim 12, wherein the hardware-based network device is configured to terminate processing of packets of the data flow in response to expiration of a TTL.

18. The system of claim 12, wherein the generation of the session information comprises parsing a plurality of rules to identify rules that are applicable to a source or destination of the data flow.

19. The system of claim 12, further comprising returning processing of packets of the data flow from the hardware-based network device to the network virtual appliance.

20. A hardware-based network interface device configured to perform operations comprising:
forwarding, to a network virtual appliance, a first data packet of a data flow addressed to an endpoint hosted on one of a plurality of virtual machines;
receiving, from the network virtual appliance, a request to offload processing of subsequent packets of the data flow in accordance with a match action associated with the data flow;
based on content of the request, generating session information associated with the data flow, wherein the session information enables offloading of processing of the subsequent data packets associated with the data flow from the network virtual appliance to the hardware-based network interface device;
applying the match action associated with the data flow to the subsequent data packets, wherein the application of the match action is disaggregated from physical dependencies on a computing node that is hosting the network virtual appliance; and
forwarding the processed subsequent data packets to the endpoint, thereby enabling the subsequent data packets to be processed by the hardware-based network device without being forwarded to or processed by the network virtual appliance.
